(19) United States
(12) Patent Application Publication
(10) Pub. No.: US 2021/0288452 A1
(43) Pub. Date: Sep. 16, 2021

(54) SMART PLUG

(71) Applicant: Marvin Moses GLAZERMAN, Jersey City, NJ (US)

(72) Inventor: Marvin Moses GLAZERMAN, Jersey City, NJ (US)

(21) Appl. No.: 16/819,330

(22) Filed: Mar. 16, 2020

(51) Int. Cl. H01R 13/70; H01R 13/66; H04B 17/318; G06F 9/4401

(52) U.S. Cl. CPC H01R 13/70; G06F 9/4401; H04B 17/318; H01R 13/6683

(57) ABSTRACT

Disclosed herein are control devices comprising: a power input port; a power output port; a detector, wherein the detector is in signal communication with both a local area network and the internet; and a switch configured to control the power flow between the input port and the output port.

### FIELD OF THE INVENTION

The present invention is in the field of electronic components connected with the Internet of Things, and more specifically, is in the field of components that are configured to control the electrical flow to one or more other electronic components.

### BACKGROUND OF THE DISCLOSURE

The Internet of Things (IoT) is a network in which two or more computing devices are in communication with each other to send and receive data without any human-to-human or human-to-machine interaction. Increasingly more and more computing devices are inserted in everyday objects and machines (“IoT objects”), which have resulted in the rapid expansion of the IoT. The computing devices are found in refrigerators, ovens, clocks, HVAC equipment, and the like. Humans can connect into the IoT network and either monitor the activity of the IoT objects within the network or send commands to the network to affect a change in the behavior of one or more of the IoT objects.

Normally, IoT objects near each other, for example those IoT objects found with a single home, office, network, etc., are connected to a local area network (LAN), either through a hardwire (data line) or Wi-Fi connection. The LAN is then connected to the internet through a modem that operates through a cable, DSL, phone, or other communication lines.

At times, while the connectivity of the IoT objects within the LAN remains unbroken, the integrity of the LAN connectivity to the internet becomes compromised and the local network as a whole is unable to connect to the general internet. In these situations, users reboot the modem. In a majority of cases, the rebooting is accomplished by cutting the power to the modem for a period of time and then reconnecting the power so that the modem can go through its initial reboot steps. Most times, the problem is solved and the LAN' s connection to the general internet is resumed. Other times, the user must take further action, for example press a “reset” button on the modem after the power off/power on sequence.

Currently, the above reboot sequence can only be activated if a human can physically cut the power to the modem or physically press the “reset” button. However, the physical rebooting of the modem is not always conveniently accomplished. Many homeowners are not home during the day, office workers are not in the office at night, or others are too busy to take the time to walk over to the modem and reboot it. On many occasions, users are not immediately aware that the internet connection is lost because their devices show a strong connection to the modem, which leads to frustrations and lost productivity.

Therefore, a need exists to automatedly, without human interaction, and/or remotely reboot a modem when the internet connection is lost.

### SUMMARY OF THE INVENTION

Disclosed herein are control devices comprising: a power input port; a power output port; a detector, wherein the detector is in signal communication with both a local area network and the internet; and a switch configured to control the power flow between the input port and the output port.

### BRIEF DESCRIPTION OF THE DRAWINGS

FIG. 1 is a drawing showing the interior arrangement of one embodiment of the control device 100, as disclosed herein.

FIG. 2 is a drawing showing an embodiment of the disclosed control devices 100 in conjunction with a modem 200, as disclosed herein.

FIG. 3 is a flowchart 300 of an embodiment of the process used by the control device 100 to determine how to control the power to the modem 200, as disclosed herein.

### DETAILED DESCRIPTION OF THE EMBODIMENTS

The following features in the drawings are referred to by the following reference numbers:
100: control device
102: control device body
104: control device power input line
108: signal detector
110: switch assembly
112: output point
114: neutral wire
116: hot wire
118: switch
120: electric line
200: modem
202: modem body
204: modem power input line
206: modem plug
208: land line connection points
210: status lights
300: flow chart
302-314: flow chart steps

In one aspect, disclosed herein are control devices comprising: a power input port; a power output port; a detector, wherein the detector is in signal communication with both a local area network and the internet; and a switch configured to control the power flow between the input port and the output port.

In some embodiments, the disclosed control devices are embedded within a modem, while in other embodiments, the control devices are separate from the modem. In certain of the latter embodiments, the control device is plugged into the wall socket and the modem is plugged into the control device.

In some embodiments, the detector measures the strength of the signal. Signal strength is regularly measured in terms of the speed of data transfer in terms of megabits per second (Mbps). In certain embodiments, a lower threshold is set for the detector such that when either the download speed, i.e., the speed of acquiring data from the internet, or the upload speed, i.e., the speed of sending data to the internet, falls below the threshold, the control device affects the reboot of the modem. In some embodiments, the lower limit threshold for data transfer is set at the factory, while in other embodiments, the user sets the lower limit threshold desirous to the user.

In some embodiments, the lower threshold for download speed is set at about 2 Mbps, while in other embodiments, the threshold is set for less than 2 Mbps, for example 1 Mbps, 0.5 Mbps, 0.2 Mbps, 0.05 Mbps, and the like. In some embodiments, the lower threshold for upload speed is set at about 1 Mbps, while in other embodiments, the threshold is set for <1 Mbps, for example 0.5 Mbps, 0.2 Mbps, 0.05 Mbps, and the like.

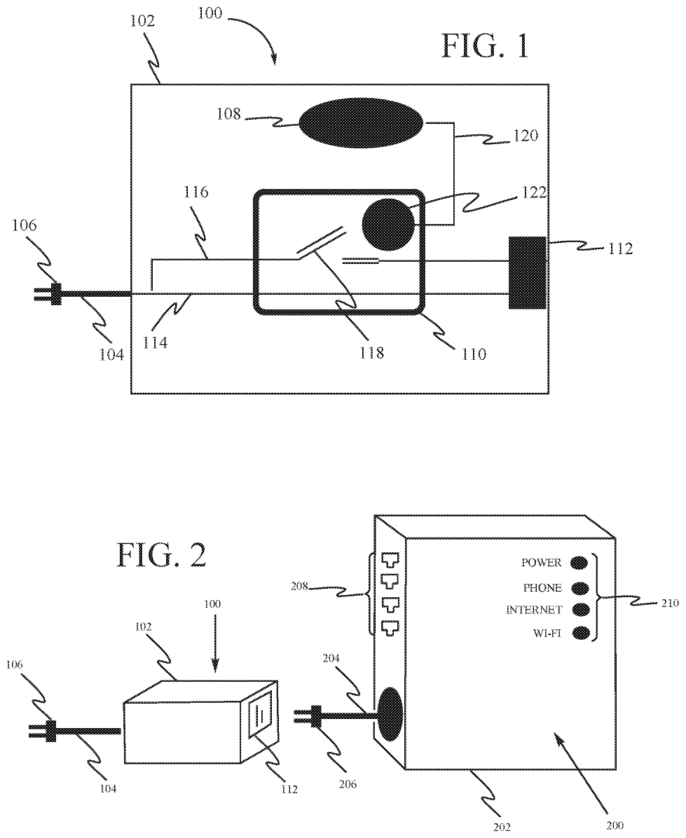

FIG. 1 depicts the interior arrangement of one embodiment of the control device 100 disclosed herein. The control device 100 comprises a body 102 that holds the various components in one place. A power input line 104 is provided that terminates distally at a standard plug suitable for plugging the device 100 into a wall socket. Depending on the country of use, the shape and size of the standard plug may vary.

In some embodiments, the interior of the control device 100 comprises at least three components, to wit: a signal detector 108, a switch assembly 110, and a power output point 112. The power input line 104 comprises between two and three wires: a hot wire, a neutral wire, and optionally a ground wire. The hot and neutral wires are herein referred to as “live” wires. The two live wires of the power input line 104 are separated inside the control device 100. The neutral wire 114 travels through the switch unbroken and terminates in the output point 112. In some embodiments, the ground wire, if present, follows the neutral wire from the input plug 106 to the output point 112. The hot wire 116, however, is broken by the switch 118. When the switch 118 is closed, the input line 104 and the output point 112 are in complete electrical communication. The electrical communication is broken, i.e., no electricity flows to the output point 112, when the switch 118 is open.

The signal detector 108 measures the download and/or upload speeds of the internet connection. In some embodiments, the detector 108 measures the speed of the Wi-Fi signal, while in other embodiments, the detector 108 measures the speed through a landline, e.g., a DSL or cable line. In still other embodiments, the detector 108 measures both the Wi-Fi and the landline speeds.

If the signal speed falls below a preset minimum threshold, then a processing unit in the detector 108 sends a signal through the electric line 120 to the switch 118 to open, and consequently shut off the power to the power output point 112. After a preset amount of time has elapsed, the detector 108 sends another signal to the switch 118, for the switch to close, and restore power to the power output point 112.

In some embodiments, the switch assembly 110 further comprises a processing unit 122. The processing unit 122 receives the signal from the detector 108 regarding the signal strength. In these embodiments, the processing unit 122 makes the final determination of whether the switch 118 is to be opened or not.

Referring now to FIG. 2, an embodiment of the disclosed control devices 100 in conjunction with a modem 200 is illustrated. The embodiment of FIG. 2 depicts the control device 100 to be external to the modem 200. The skilled artisan recognizes that the control device 100 can be embedded within the body 202 of the modem 200 and not be a separate device. An advantage of having a separate control device 100, such as that shown in FIG. 2, is that the control device 100 can be used with any modem 200, for example an already existing modem, or a new modem that does not have a built in control device 100.

The modem 200 comprises an power input line 204 having a standard plug 206 at its distal end. The plug 206 is configured to be plugged into the power output point 112 of the control device 100, thereby establishing electrical communication between the modem 200 and the control device 100.

In some embodiments, the modem 200 is only a Wi-Fi modem. In other embodiments, such as the one shown in FIG. 2, the modem 200 supports both Wi-Fi connections and land line connections. In some of these embodiments, the modem 200 comprises a plurality of connection points 208 for land line, e.g., CATS, cable, phone line, connections.

In certain embodiments, the modem 200 also comprises a plurality of status lights 210, which inform a user of the proper functioning of the various connections the modem 200 supports. For example, in some embodiments, the status lights 210 indicate whether the power is on, whether there is a phone connection, whether there is an internet connection to the outside world, and whether the Wi-Fi signal is properly sent and received.

In some embodiments, the mechanism that operates the status lights 210 in modem 200 also sends a status signal to the control device 100, which signal causes the control device 100 to control the power to the modem 200. For example, if for some reason the Wi-Fi status light is extinguished, the modem 200 notifies the control device 100 of the issue and the control device 100 then cuts the power to the modem 200 to reboot the modem 200. In certain embodiments, such manner of control is used for some or all of the status lights 210 available on the modem 200.

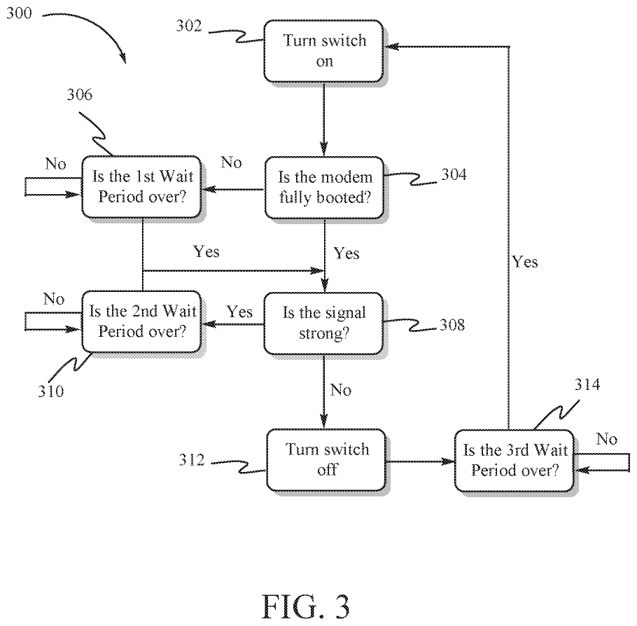

FIG. 3 shows a flowchart 300 of an embodiment of the process used by the control device 100 to determine how to control the power to the modem 200. The first step 302 is ensuring that the switch 118 is closed and power flows to the modem 200. In step 304, the control device 100 determines whether the modem 200 is fully booted. This determination is made by checking the status of the status lights 210, while in other embodiments, the control device 100 determines the upload/download speed of the modem 200, for example through the use of the signal detector 108 by checking the internet. If the modem is not fully booted, then the process shifts to step 306, where the control device 100 pauses for a pre-determined first wait period. In some embodiments, the first wait period is shorter than one minute, while in other embodiments, the first wait period is shorter than five minutes.

After the conclusion of the first wait period and/or after the determination that the modem is fully booted, in step 308 the control device 100 checks the strength of the signal. If the signal is of sufficient strengths, i.e., if the signal is stronger than a pre-selected minimum threshold, then in step 310 the control device 100 pauses for a second wait period and then checks the signal again. In some embodiments, the second wait period is shorter than one minute, while in other embodiments, the second wait period is shorter than five minutes.

If the signal is detected to be below the pre-selected minimum threshold level, then in step 312 the control device 100 opens the switch 118 and stops the flow of electricity to the modem 200. After pausing for a third wait period in step 314, the control device 100 re-closes the switch 118 and re-establishes the flow of electricity to the modem 200. In some embodiments, the third wait period is shorter than five minutes or shorter one minute, while in other embodiments, the third wait period is shorter than thirty seconds.

The first wait period, the second wait period, and the third wait period are each independently either pre-programed at the factory or manually inputted by the user.

What is claimed is:

1. A control device 100 comprising:
a power input line 104 that terminates distally at a standard plug configured for plugging the control device 100 into a wall socket;
a signal detector 108, wherein the detector is in signal communication with both a local area network and the internet;
a switch assembly 110, configured to control the power flow between the input port and the output port; and
a power output point 112.

2. The control device of claim 1, wherein the control device is embedded within a modem.

3. The control device of claim 1, wherein the control device is separate from the modem.

4. The control device of claim 3, wherein the control device is plugged into the wall socket and the modem is plugged into the control device.

5. The control device of claim 1, wherein the detector measures the strength of the signal in terms of the speed of data transfer.

6. The control device of claim 5, wherein a lower threshold is set for the detector such that when either a download speed and/or an upload speed falls below the threshold, the control device affects the reboot of the modem.

7. The control device of claim 6, wherein the lower threshold for download speed, if present, is set at a threshold selected from about 2 Mbps, <2 Mbps, 1 Mbps, 0.5 Mbps, 0.2 Mbps, or 0.05 Mbps; while the lower threshold for upload speed, if present, is set at about 1 Mbps, <1 Mbps, 0.5 Mbps, 0.2 Mbps, or 0.05 Mbps.

8. The control device of claim 1, wherein the switch assembly 110 further comprises a processing unit 122, which receives a signal from the detector 108 regarding the signal strength.

9. The control device of claim 1, wherein the control device is in electrical communication with a modem.

10. A method of rebooting a modem, the method comprising the steps of:
connecting a modem 200 to a control device 100 of claim 1;
allowing power to flow to the modem 200;
checking a strength of a signal to and/or from the modem 200;
cutting the power to the modem 200 if the signal strength falls below a pre-determined minimum threshold level; and
reconnecting the modem 200 to the power after a wait period has elapsed.
